(19) United States
(12) Patent Application Publication
(10) Pub. No.: US 2002/0024936 A1
(43) Pub. Date: Feb. 28, 2002

(54) System, method and record medium for packet transmission capable of reducing delay due to resource assignment

(75) Inventor: Masatoshi Yamamoto, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/927,348

(22) Filed: Aug. 13, 2001

(30) Foreign Application Priority Data
Aug. 11, 2000 (JP) 2000-244891

(51) Int. Cl. H04L 12/26

(52) U.S. Cl. 370/252; 370/335

(57) ABSTRACT

In a packet transmission system, each terminal unit transmits data to a resource monitoring device of a network for sending the data to another terminal unit via the network. The resource monitoring device includes a resource map database and a resource management section. The resource map database stores a resource map in which central points of resources that can be used by the terminal units are described. The resource management section transmits the resource map to the terminal units. Each terminal unit includes a resource detection section and a resource acquisition section. The resource detection section detects resource usage statuses of terminal units that are using resources adjacent to a resource used by the terminal unit, by use of the resource map supplied from the resource monitoring device. The resource acquisition section finds idle resources between the resource used by the terminal unit and the adjacent resources based on the resource usage statuses detected by the resource detection section, and acquires all or part of the idle resources so as to be incorporated in the usable resource of the terminal unit. By employing such resource assignment, the number of messages necessary for the resource assignment can be reduced and thereby delay time due to the resource assignment can be reduced.

### BACKGROUND OF THE INVENTION

The present invention relates to a system and a method for packet transmission for communicating data among a plurality of remotely placed terminal units, and in particular, to a system and a method for packet transmission in which delay time caused by resource assignment can be reduced and thereby data transmission throughput can be increased.

### DESCRIPTION OF THE RELATED ART

Packet transmission has been carried out by means of, for example, TDMA (Time Division Multiple Access), in which a frequency band is time-divided so as to be used by a plurality of users simultaneously.

However, TDMA does not have means for changing resources depending on the amount of data to be transmitted. Therefore, even when burst data have to be transmitted, only a fixed frequency band is allowed to be used and thus it has been impossible to improve the maximum data transmission rate.

Meanwhile, CDMA (Code Division Multiple Access) is attracting considerable attention in recent years as a means for resolving the above problems. In the case of CDMA, a lot of channels are assigned to a frequency band and resources can be changed dynamically, thereby the maximum data transmission rate can be increased dramatically in comparison with TDMA.

Such technologies for changing resources depending on the amount of transmitted data have been studied by 3GPP (a standards setting body for W-CDMA), for example. FIG. 1 is a block diagram showing an example of a packet transmission system studied and discussed by 3GPP. In the packet transmission system of FIG. 1, terminal units A, B and C are capable of making access to a resource monitoring device 2 of a network 1. The resource monitoring device 2 is provided to, for example, a node of the network 1.

Each terminal unit shown in FIG. 1 (terminal unit A, for example) is provided with a transmission buffer 15 for storing data to be transmitted to the network 1 (to the resource monitoring device 2). The resource monitoring device 2 includes a resource map database 5 and a resource management section 7. The resource map database 5 stores a resource map 8 in which resources that should be used by the terminal units A, B and C are mapped. The resource management section 7 receives a resource request from a terminal unit that is going to transmit data, and determines a resource that should be used by the terminal unit.

In the following, the operation of the conventional packet transmission system will be explained referring to FIG. 1. Data to be transmitted by the terminal unit A is successively stored in the transmission buffer 15 of the terminal unit A. The terminal unit A sends a resource request signal to the resource monitoring device 2 depending on the amount of the data stored in the transmission buffer 15. In the resource monitoring device 2 which received the resource request signal, the resource management section 7 determines a resource to be used by the terminal unit A in consideration of total resources and sends a resource assignment signal (designating a resource that is assigned to the terminal unit A) to the terminal unit A. The terminal unit A which received the resource assignment signal transmits data by use of the resource that is designated by the resource assignment signal.

In the conventional packet transmission system of FIG. 1, when a terminal unit (terminal unit A, for example) needs to enlarge its resource width for data transmission, the terminal unit A has to communicate some messages with the resource monitoring device 2. However, a relatively long delay time (on the order of 100 ms) exists between the terminal unit A and the resource monitoring device 2, and thus it is very difficult to increase data transmission throughput (especially in packet transmission systems employing error correction by means of retransmission control) because of the accumulation of the delay time.

### SUMMARY OF THE INVENTION

It is therefore the primary object of the present invention to provide a packet transmission system, a packet transmission method and a record medium for packet transmission, by which the delay time concerning the resource assignment can be reduced and thereby the data transmission throughput can be increased.

In accordance with a first aspect of the present invention, there is provided a packet transmission system in which each terminal unit (A, B, C) transmits data to a resource monitoring device (2) of a network (1) for sending the data to another terminal unit via the network (1). In the packet transmission system, the resource monitoring device (2) includes a resource map database (5) and a resource management means (7). The resource map database (5) stores a resource map (8) in which central points of resources that can be used by the terminal units (A, B, C) are described. The resource management means (7) obtains the resource map (8) from the resource map database (5) and transmits the resource map (8) to the terminal units (A, B, C). Each terminal unit (A, B, C) includes a resource detection means (3) and a resource acquisition means (4). The resource detection means (3) detects resource usage statuses (10B) of terminal units that are using resources adjacent to a resource used by the terminal unit (A, B, C) to which the resource detection means (3) belongs, by use of the resource map (8) supplied from the resource monitoring device (2). The resource acquisition means (4) finds idle resources between the resource used by the terminal unit (A, B, C) and the adjacent resources based on the resource usage statuses (10B) detected by the resource detection means (3), and acquires all or part of the idle resources so as to be incorporated in the usable resource (12) of the terminal unit (A, B, C).

In accordance with a second aspect of the present invention, in the first aspect, the resource monitoring device (2) further includes a resource monitoring means (6) for monitoring resource usage statuses (10A) of the terminal units (A, B. C) by monitoring packet traffic from the terminal units (A, B, C). The resource management means (7) includes a resource map update means (7). The resource map update means (7) receives the resource usage statuses (10A) of the terminal units (A, B, C) from the resource monitoring means (6), finds a terminal unit whose resource is insufficient by use of the resource usage statuses (10A), and updates the resource map (8) by setting a reservation resource reference point (13) in an appropriate idle zone of the resource map (8) so as to be used as the central point of a usable resource (12) which is newly assigned to the terminal unit whose resource is insufficient. The resource acquisition means (4) of terminal units that are using resources adjacent to the reservation resource reference point (13) in the updated resource map (8) reduce their resources so that an idle resource zone (14) will be prepared around the reservation resource reference point (13). The resource acquisition means (4) of the terminal unit whose resource is insufficient sets a new resource for the terminal unit in the idle resource zone (14).

In accordance with a third aspect of the present invention, in the first aspect, the data transmission from the terminal units (A, B, C) to the resource monitoring device (2) is executed by means of CDMA (Code Division Multiple Access).

In accordance with a fourth aspect of the present invention, in the first aspect, the resource acquisition means (4) acquires approximately 50% of the idle resources so as to be incorporated in the usable resource (12) of the terminal unit (A, B, C).

In accordance with a fifth aspect of the present invention, there is provided a packet transmission method for a packet transmission system in which each terminal unit (A, B, C) transmits data to a resource monitoring device (2) of a network (1) for sending the data to another terminal unit via the network (1). The packet transmission method comprises a resource map reception step, an adjacent resource usage status detection step and a resource acquisition step. In the resource map reception step, each terminal unit (A, B, C) receives a resource map (8) from the resource monitoring device (2). In the resource map (8), central points of resources that can be used by the terminal units (A, B, C) are described. In the adjacent resource usage status detection step, the terminal unit (A, B, C) detects resource usage statuses (10B) of terminal units that are using resources adjacent to a resource used by the terminal unit (A, B, C), by use of the resource map (8) supplied from the resource monitoring device (2). In the resource acquisition step, the terminal unit (A, B, C) finds idle resources between the resource used by the terminal unit (A, B, C) and the adjacent resources based on the resource usage statuses (10B) detected in the adjacent resource usage status detection step, and acquires all or part of the idle resources so as to be incorporated in the usable resource (12) of the terminal unit (A, B, C).

In accordance with a sixth aspect of the present invention, in the fifth aspect, the packet transmission method further comprises a resource usage status monitoring step, a resource map update step, a resource reduction step and a resource setting step. In the resource usage status monitoring step, the resource monitoring device (2) monitors resource usage statuses (10A) of the terminal units (A, B, C) by monitoring packet traffic from the terminal units (A, B, C). In the resource map update step, the resource monitoring device (2) finds a terminal unit whose resource is insufficient by use of the resource usage statuses (10A) and updates the resource map (8) by setting a reservation resource reference point (13) in an appropriate idle zone of the resource map (8) so as to be used as the central point of a usable resource (12) which is newly assigned to the terminal unit whose resource is insufficient. In the resource reduction step, terminal units that are using resources adjacent to the reservation resource reference point (13) in the updated resource map (8) reduce their resources so that an idle resource zone (14) will be prepared around the reservation resource reference point (13). In the resource setting step, the terminal unit whose resource is insufficient sets its new resource in the idle resource zone (14) prepared in the resource reduction step.

In accordance with a seventh aspect of the present invention, in the fifth aspect, the data transmission from the terminal units (A, B, C) to the resource monitoring device (2) is executed by means of CDMA (Code Division Multiple Access).

In accordance with an eighth aspect of the present invention, in the resource acquisition step of the fifth aspect, the terminal unit (A, B, C) acquires approximately 50% of the idle resources so as to be incorporated in the usable resource (12) of the terminal unit (A, B, C).

In accordance with ninth through twelfth aspects of the present invention, there are provided machine-readable record mediums (floppy disks, CD-ROMs, DVD-ROMs, HDDs, optical disks, etc.) storing programs for instructing one or more computers to execute the packet transmission methods of the fifth through eighth aspects of the present invention.

### BRIEF DESCRIPT10N OF THE DRAWINGS

The objects and features of the present invention will become more apparent from the consideration of the following detailed description taken in conjunction with the accompanying drawings, in which:

FIG. 1 is a block diagram showing an example of a packet transmission system studied and discussed by 3GPP;

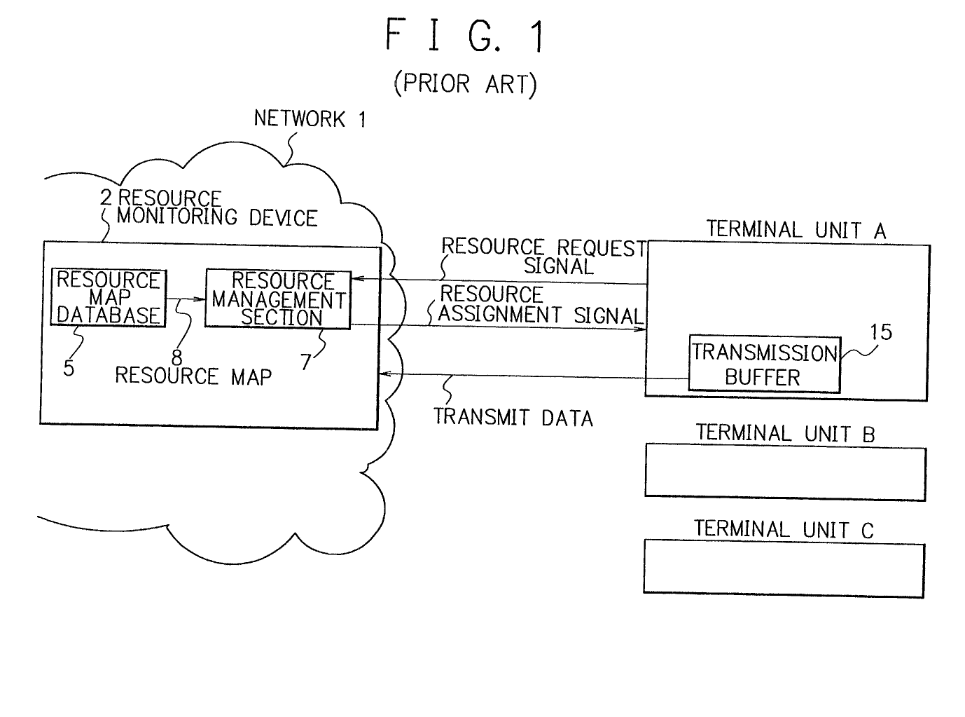

FIG. 2 is a block diagram showing a packet transmission system in accordance with an embodiment of the present invention;

FIG. 3 is a schematic diagram showing the operation of a resource acquisition section of each terminal unit shown in FIG. 2 for judging and determining a resource that can be used by the terminal unit; and

FIG. 4 is a schematic diagram showing the operation of a resource management section of a resource monitoring device shown in FIG. 2 for assigning appropriate resources to the terminal units for the effective use of the resources.

### DESCRIPTION OF THE PREFERRED EMBODIMENTS

Referring now to the drawings, a description will be given in detail of preferred embodiments in accordance with the present invention.

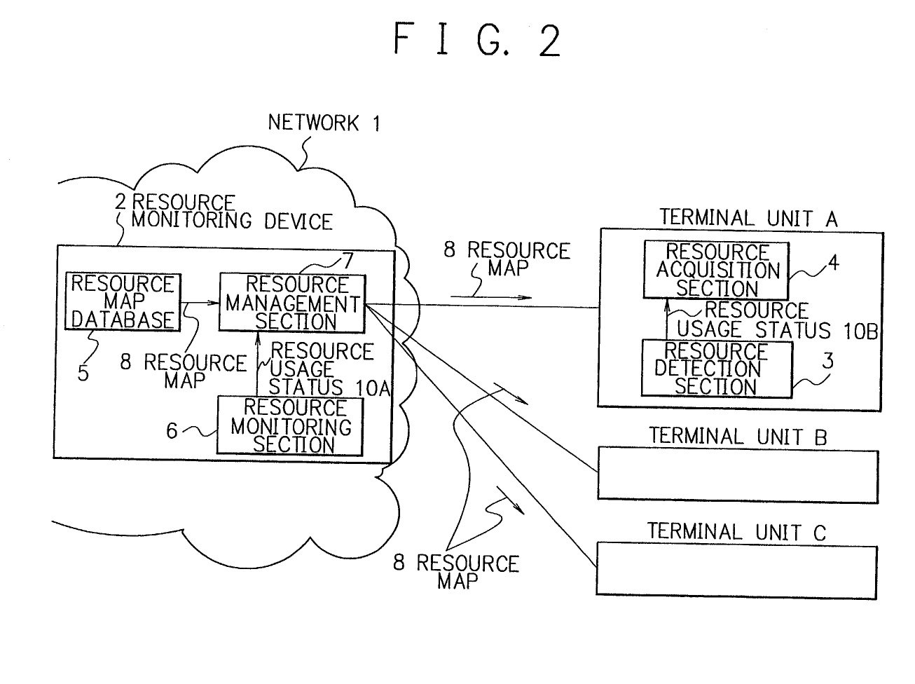

FIG. 2 is a block diagram showing a packet transmission system in accordance with an embodiment of the present invention. The packet transmission system of FIG. 2 includes a network 1 and terminal units A, B and C. The network 1 includes one or more resource monitoring devices 2 which are provided to, for example, nodes (radio base stations etc.) of the network 1.

Each terminal unit (personal computer, cellular phone, etc.) transmits data (packets) to a resource monitoring device 2 of the network 1 for sending the data to other terminal units via the network 1. The data communication between each terminal unit and the resource monitoring device 2 is executed by means of, for example, CDMA (Code Division Multiple Access) such as TDD (Time Division Duplex) CDMA. Each terminal unit includes a resource detection section 3 and a resource acquisition section 4.

The resource detection section 3 of a terminal unit detects and monitors resource usage statuses of other terminal units that are using “adjacent resources” (that is, resources that are adjacent to the resource being used by the terminal unit), and informs the resource acquisition section 4 about the resource usage statuses (resource usage status 10B).

The resource acquisition section 4 of a terminal unit judges and determines a resource that can be used by the terminal unit based on the resource usage status 10B supplied from the resource detection section 3 and a resource map 8 which is supplied from the resource monitoring device 2. The terminal unit transmits data to the resource monitoring device 2 using the resource acquired (judged and determined) by the resource acquisition section 4.

The resource monitoring device 2 includes a resource map database 5, a resource monitoring section 6 and a resource management section 7. The resource map database 5 stores a resource map 8 in which resources that should be used by the terminal units A, B and C are mapped. The resource map 8 stored in the resource map database 5 is supplied to the resource management section 7. The resource monitoring section 6 monitors transmit data which are transmitted by the terminal units A, B and C and thereby detects resources which are being used by the terminal units A, B and C. The resource monitoring section 6 which detected the resource usage statuses of the terminal units A, B and C (resource usage status 10A) informs the resource management section 7 about the resource usage status 10A. The resource management section 7 changes the resource mapping for the terminal units A, B and C in the resource map 8 if necessary referring to the resource map 8 supplied from the resource map database 5 and the resource usage status 10A supplied from the resource monitoring section 6. The resource management section 7 which updated the resource map 8 supplies the updated resource map 8 to the terminal units A, B and C and stores the updated resource map 8 in the resource map database 5.

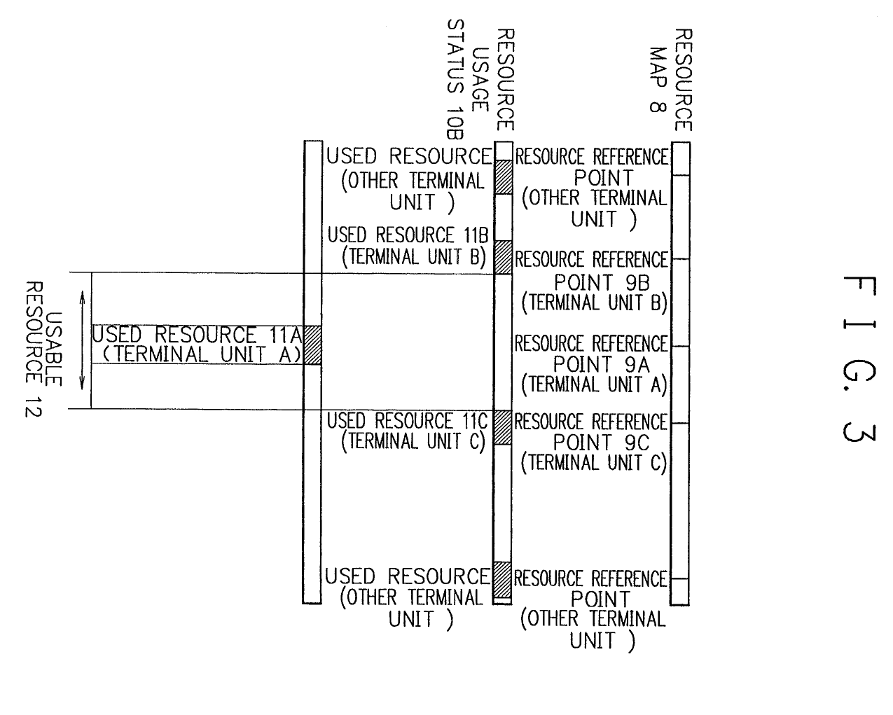

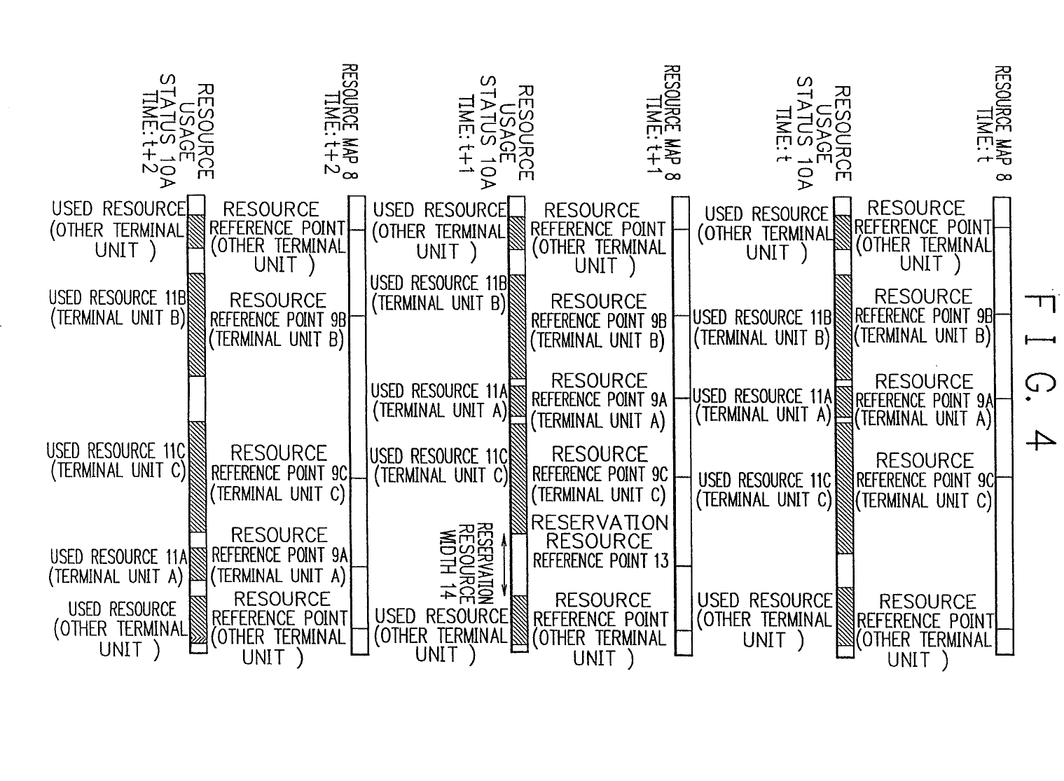

In the following, the operation of the packet transmission system of FIG. 2 will be explained referring to FIGS. 3 and 4. FIG. 3 is a schematic diagram showing the operation of the resource acquisition section 4 of each terminal unit for judging and determining a resource that can be used by the terminal unit. FIG. 4 is a schematic diagram showing the operation of the resource management section 7 of the resource monitoring device 2 for assigning appropriate resources to the terminal units A, B and C for the effective use of the resources.

First, the operation of the resource acquisition section 4 of each terminal unit (terminal unit A, for example) for determining a usable resource will be explained in detail referring to FIG. 3. The resource monitoring device 2 sends the resource map 8 which has been stored in the resource map database 5 to the terminal units A, B and C. In the resource map 8 which is supplied to each terminal unit, the central point of each resource that can be used by each terminal unit is described. The central point of each resource for each terminal unit will hereafter be referred to as “resource reference point”. In the example of FIG. 3, a resource reference point 9A for the terminal unit A, a resource reference point 9B for the terminal unit B, and a resource reference point 9C for the terminal unit C are described in the resource map 8.

The resource acquisition section 4 of the terminal unit A refers to the resource map 8 supplied from the resource monitoring device 2 and finds that other terminal units that are using “adjacent resources” (that is, resources that are adjacent to the resource used by the terminal unit A) are the terminal units B and C. Since the terminal units B and C are using the “adjacent resources”, the resource detection section 3 monitors transmit data that are transmitted by the terminal units B and C and thereby detects resource usage statuses of the terminal units B and C. In the case where the data transmission from each terminal unit to the resource monitoring device 2 is executed by means of CDMA, the resource detection section 3 calculates the correlation between the transmit data and each code pattern for the detection of the resource usage statuses. The resource detection section 3 which detected the resource usage statuses of the terminal units B and C (resource usage status 10B) informs the resource acquisition section 4 about the resource usage status 10B. In the resource usage status 10B shown in FIG. 3, a resource which is being used by the terminal unit B (“used resource 11B”) and a resource which is being used by the terminal unit C (“used resource 11C”) are described. The resource acquisition section 4 of the terminal unit A also manages and supervises a resource which is being used by the terminal unit A as “used resource 11A”.

Subsequently, the resource acquisition section 4 of the terminal unit A determines a resource (usable resource 12) that can be used by the terminal unit A. The resource acquisition section 4 first finds idle resources between its own resource and the adjacent resources. In the example of FIG. 3, the resource acquisition section 4 finds a left-hand idle resource existing between the “used resource 11A” and the “used resource 11B” and a right-hand idle resource existing between the “used resource 11A” and the “used resource 11C”. Subsequently, the resource acquisition section 4 determines a resource that can be used by the terminal unit A (usable resource 12) avoiding resource conflicts with other terminal units, in consideration of the left-hand idle resource and the right-hand idle resource. In the example of FIG. 3, the resource acquisition section 4 acquires halves (50%) of the left-hand idle resource and the right-hand idle resource so as to be incorporated in the usable resource 12 of the terminal unit A. Thereafter, the terminal unit A transmits its transmit data (packets) to the resource monitoring device 2 using the usable resource 12.

Next, the operation of the resource management section 7 of the resource monitoring device 2 for assigning appropriate resources to the terminal units A, B and C (terminal unit A, for example) for the effective use of the resources will be explained in detail referring to FIG. 4. The resource monitoring section 6 of the resource monitoring device 2 monitors transmit data which are transmitted by the terminal units A, B and C and thereby detects resource usage statuses of the terminal units A, B and C. The resource monitoring section 6 which detected the resource usage statuses of the terminal units A, B and C (resource usage status 10A) informs the resource management section 7 about the resource usage status 10A. If the resource management section 7 (referring to the resource usage status 10A and using a resource insufficiency detection program etc.) judged that the resource 11A which has been assigned to the terminal unit A is insufficient, the resource management section 7 executes resource relocation for the terminal unit A.

FIG. 4 shows a case where the resource management section 7 conducts the resource relocation for the terminal unit A in a time interval [t, t+2]. For executing the resource relocation for the terminal unit A, the resource management section 7 first sets a “reservation resource reference point 13” in an appropriate idle zone of the resource map 8 in which the relocated resource should be placed, and includes the reservation resource reference point 13 in a new resource map 8 which will be supplied to the terminal units (as shown in the resource map 8 of FIG. 4 at time t+1). The new resource map 8 including the reservation resource reference point 13 is supplied to the terminal units A, B, C, etc., and thereby the terminal unit B and another terminal unit which are using resources adjacent to the reservation resource reference point 13 are controlled to make room for a predetermined “reservation resource width 14” around the reservation resource reference point 13. In short, the reservation resource width 14 needed by the terminal unit A is secured by forcibly reducing resource widths of terminal units that are using resources adjacent to the reservation resource reference point 13. After the reservation resource width 14 for the terminal unit A has been secured, the resource relocation for the terminal unit A is executed (as shown in the resource map 8 of FIG. 4 at time t+2).

Incidentally, the resource assignment process which has been explained above is employed by the resource management section 7 also when another terminal unit is newly connected to the resource monitoring device 2.

While the resource acquisition section 4 of the terminal unit A in the above explanation acquired 50% of the left-hand idle resource and the right-hand idle resource so as to be incorporated in the usable resource 12, it is also possible to vary the percentage or priority among terminal units in consideration of conditions such as packet supporting/non-supporting, maximum data transmission rate, etc. In a terminal unit that does not support packet transmission, rapid increase of the resource width does not occur, and thus the resource acquisition section 4 can acquire the whole (100%) of the idle resources for the usable resource 12. It is also possible to give higher priority to terminal units that are required high-speed data transmission and set a higher percentage for such high-speed terminal units.

As described above, in the packet transmission system and the packet transmission method in accordance with the embodiment of the present invention, each terminal unit that is going to transmit packets can autonomously change its resource width depending on the amount of upstream data to be transmitted, by use of the resource map 8 which is supplied from the resource monitoring device 2. Therefore, the number of messages that have to be communicated between the terminal unit and the resource monitoring device 2 for the resource assignment (resource width alternation) can be reduced, thereby the delay time concerning the resource assignment can be reduced, and thereby the data transmission throughput can be increased. Basically, the resource monitoring device 2 does not have to manage and control the resources which are used by each of the terminal units, therefore, the load on the resource monitoring device 2 for the resource assignment can be reduced in comparison with the case of the conventional packet transmission system.

The resource monitoring device 2 in the above embodiment is also provided with a function for executing the resource relocation for a terminal unit whose resource is insufficient by setting the reservation resource reference point 13 in an appropriate idle zone of the resource map 8. The new resource map 8 including the reservation resource reference point 13 is supplied to the terminal units, and thereby the reservation resource width 14 needed by the terminal unit whose resource is insufficient is secured around the reservation resource reference point 13. Therefore, the resources can be assigned and distributed to the terminal units appropriately and the effective use of the resources is realized.

Incidentally, the operation of the terminal unit (A, B, C) or the resource monitoring device 2 in the packet transmission system which has been described above can be implemented by specially-designed hardware operated by specific software, however, it can also be implemented by use of a general-purpose computer and a machine-readable record medium (floppy disk, CD-ROM, DVD-ROM, HDD, optical disk, etc.) storing one or more programs for instructing the computer to execute the packet transmission method described above. The programs stored in the machine-readable record medium are read out by the computer and thereby the computer operates as the terminal unit (A, B, C) or the resource monitoring device 2 of the above embodiment.

The communication method employed for the data communication between the resource monitoring device 2 and the terminal units (A, B, C) is not limited to CDMA, and thus the present invention can be applied to various packet transmission systems using various resources (code patterns, time slots, frequency bands, etc.).

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A packet transmission system in which each terminal unit transmits data to a resource monitoring device of a network for sending the data to another terminal unit via the network, wherein:
the resource monitoring device includes:
a resource map database for storing a resource map in which central points of resources that can be used by the terminal units are described; and
a resource management means for obtaining the resource map from the resource map database and transmitting the resource map to the terminal units, and
each terminal unit includes:
a resource detection means for detecting resource usage statuses of terminal units that are using resources adjacent to a resource used by the terminal unit to which the resource detection means belongs by use of the resource map supplied from the resource monitoring device; and
a resource acquisition means for finding idle resources between the resource used by the terminal unit and the adjacent resources based on the resource usage statuses detected by the resource detection means and acquiring all or part of the idle resources so as to be incorporated in the usable resource of the terminal unit.

2. A packet transmission system as claimed in claim 1, wherein:
the resource monitoring device further includes a resource monitoring means for monitoring resource usage statuses of the terminal units by monitoring packet traffic from the terminal units, and
the resource management means includes a resource map update means for receiving the resource usage statuses of the terminal units from the resource monitoring means, finding a terminal unit whose resource is insufficient by use of the resource usage statuses, and updating the resource map by setting a reservation resource reference point in an appropriate idle zone of the resource map so as to be used as the central point of a usable resource which is newly assigned to the terminal unit whose resource is insufficient, and
the resource acquisition means of terminal units that are using resources adjacent to the reservation resource reference point in the updated resource map reduce their resources so that an idle resource zone will be prepared around the reservation resource reference point, and
the resource acquisition means of the terminal unit whose resource is insufficient sets a new resource for the terminal unit in the idle resource zone.

3. A packet transmission system as claimed in claim 1, wherein the data transmission from the terminal units to the resource monitoring device is executed by means of CDMA (Code Division Multiple Access).

4. A packet transmission system as claimed in claim 1, wherein the resource acquisition means acquires approximately 50% of the idle resources so as to be incorporated in the usable resource of the terminal unit.

5. A packet transmission method for a packet transmission system in which each terminal unit transmits data to a resource monitoring device of a network for sending the data to another terminal unit via the network, comprising the steps of
a resource map reception step in which each terminal unit receives a resource map in which central points of resources that can be used by the terminal units are described from the resource monitoring device;
an adjacent resource usage status detection step in which the terminal unit detects resource usage statuses of terminal units that are using resources adjacent to a resource used by the terminal unit by use of the resource map supplied from the resource monitoring device; and
a resource acquisition step in which the terminal unit finds idle resources between the resource used by the terminal unit and the adjacent resources based on the resource usage statuses detected in the adjacent resource usage status detection step and acquires all or part of the idle resources so as to be incorporated in the usable resource of the terminal unit.

6. A packet transmission method as claimed in claim 5, further comprising:
a resource usage status monitoring step in which the resource monitoring device monitors resource usage statuses of the terminal units by monitoring packet traffic from the terminal units;
a resource map update step in which the resource monitoring device finds a terminal unit whose resource is insufficient by use of the resource usage statuses and updates the resource map by setting a reservation resource reference point in an appropriate idle zone of the resource map so as to be used as the central point of a usable resource which is newly assigned to the terminal unit whose resource is insufficient;
a resource reduction step in which terminal units that are using resources adjacent to the reservation resource reference point in the updated resource map reduce their resources so that an idle resource zone will be prepared around the reservation resource reference point; and
a resource setting step in which the terminal unit whose resource is insufficient sets its new resource in the idle resource zone prepared in the resource reduction step.

7. A packet transmission method as claimed in claim 5, wherein the data transmission from the terminal units to the resource monitoring device is executed by means of CDMA (Code Division Multiple Access).

8. A packet transmission method as claimed in claim 5, wherein in the resource acquisition step, the terminal unit acquires approximately 50% of the idle resources so as to be incorporated in the usable resource of the terminal unit.

9. A machine-readable record medium storing one or more programs for instructing one or more computers to execute a packet transmission method for a packet transmission system in which each terminal unit transmits data to a resource monitoring device of a network for sending the data to another terminal unit via the network, wherein the packet transmission method comprises the steps of:
a resource map reception step in which each terminal unit receives a resource map in which central points of resources that can be used by the terminal units are described from the resource monitoring device;
an adjacent resource usage status detection step in which the terminal unit detects resource usage statuses of terminal units that are using resources adjacent to a resource used by the terminal unit by use of the resource map supplied from the resource monitoring device; and
a resource acquisition step in which the terminal unit finds idle resources between the resource used by the terminal unit and the adjacent resources based on the resource usage statuses detected in the adjacent resource usage status detection step and acquires all or part of the idle resources so as to be incorporated in the usable resource of the terminal unit.

10. A machine-readable record medium as claimed in claim 9, wherein the packet transmission method implemented by the computers and the programs further comprises:
a resource usage status monitoring step in which the resource monitoring device monitors resource usage statuses of the terminal units by monitoring packet traffic from the terminal units;
a resource map update step in which the resource monitoring device finds a terminal unit whose resource is insufficient by use of the resource usage statuses and updates the resource map by setting a reservation resource reference point in an appropriate idle zone of the resource map so as to be used as the central point of a usable resource which is newly assigned to the terminal unit whose resource is insufficient;
a resource reduction step in which terminal units that are using resources adjacent to the reservation resource reference point in the updated resource map reduce their resources so that an idle resource zone will be prepared around the reservation resource reference point; and
a resource setting step in which the terminal unit whose resource is insufficient sets its new resource in the idle resource zone prepared in the resource reduction step.

11. A machine-readable record medium as claimed in claim 9, wherein the data transmission from the terminal units to the resource monitoring device is executed by means of CDMA (Code Division Multiple Access).

12. A machine-readable record medium as claimed in claim 9, wherein in the resource acquisition step, the terminal unit acquires approximately 50% of the idle resources so as to be incorporated in the usable resource of the terminal unit.
